(19) United States
(12) Patent Application Publication
(10) Pub. No.: US 2010/0060091 A1
(43) Pub. Date: Mar. 11, 2010

(54) ELECTROMAGNETIC ROTOR MACHINE

(76) Inventor: Robert Nordgren, Flen (SE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/162,244

(22) PCT Filed: Jan. 26, 2007
(86) PCT No.: PCT/SE07/00073

§ 371 Date: Jan. 19, 2009

(30) Foreign Application Priority Data
Jan. 27, 2006 (SE) 0600174-7

(51) Int. Cl. H02K 41/06; H02K 7/00

(52) U.S. Cl. 310/80; 310/273

(57) ABSTRACT

An electromagnetic rotor machine (10) of the hypocycloid type comprising a machine housing (12), an annular stator (30) in the machine housing an annular rotor (50) of a magnetic material, which is supported orbiting and rotationally around it's own axis in the machine housing, and at an interior side thereof adapted to operatively engage a drive element supported in the machine housing. The stator (30) comprises circumferentially arranged electromagnets which are magnetically separated from each other, each of said magnets comprising a core (34) and a coil (36) and being arranged in such a number that a plurality of magnets always is located at a side of the rotor (50).

### TECHNICAL AREA

The present invention relates to an electromagnetic rotor machine of the hypocycloid type. Such machines are known, for example from U.S. Pat. Nos. 2,761,079, 3,560,774, 4,482,828 and 5,703,422.

### BACKGROUND

For example, electrical fork lift trucks are normally powered by conventional DC motors. The development of power electronics has made asynchronous motors more common. The torque requirements are so high that the power train includes a gear transmission. Other types of motors such as servo motors magnetized by permanent magnets and SR (Switched Reluctance) motors have also been tested. Applications using direct drives without any transmission between motor and driving wheels can also be found. As the torque of the motor and its radius are directly related, the motor will have a large diameter and a high cost. In systems having a fixed transmission ratio, the maximum speed is limited by the physical limits for the motor speed. In DC drives the power electronics also set limitations on the frequency that can be used. The losses increase with higher frequences.

### SUMMARY OF THE INVENTION

An object of the present invention is to develop further a rotor machine of the above defined type, in order that its inherent advantages of a high torque and a compact construction may be utilized, particularly when it is used as a motor

This object is obtained by the features defined in the appended claims.

In an aspect of the invention the rotor is an annular rotor made of a magnetic material and supported orbiting and rotationally around its own axis in the machine housing and at an interior side thereof adapted to operatively engage a drive element supported in the machine housing. Thereby the rotor can be distinctively guided in an orbit close to the stator in the machine housing to securely and uniformly interact with the drive element and the stator.

The stator further comprises circumferentially arranged electromagnets which are magnetically separated from each other, each of said magnets comprising a core and a coil and being arranged in such a number that a plurality of magnets always is located at an arbitrary side of the rotor. By “a side of the rotor” is here intended to be construed approximately as a half circumference of the rotor projected in a direction. Thereby the rotor can cooperate with a plurality of magnets at a time, so that for example when the machine is a motor, then one or more electromagnets can optionally attract the rotor depending on the current need for torque. Using a suitable control, the motor should then be capable of having better low speed characteristics and thereby a relatively large speed variation which is particularly important when it is used for vehicle propulsion purposes.

The magnet coils are in an embodiment oriented so that their windings lie in planes parallel to the longitudinal axis of the machine. i.e. the coils extend approximately tangentially or in a direction transversely to the longitudinal axis. In an advantageous manner, the poles of the magnets may be arranged in a tangential direction in the stator.

According to an embodiment of the invention, the rotor is in rolling engagement in the machine housing and the drive element is a collar-shaped carrier capable of transmitting rotational movement from the rotor to a shaft concentrically journalled in the machine housing. Obtained is thereby a very compact and efficient power transmission between the rotor and the shaft. The one end of the carrier is then suitably connected to an axial end of the rotor and its other end is connected to the shaft. The carrier will then perform a conical orbiting movement about the shaft. In addition to propulsion of vehicles, a rotor machine according the invention arranged as a motor can be used as a servomotor, for example for actuators and industrial robots.

The rotor machine can also have means for engaging and disengaging the carrier respectively to and from the shaft.

If the shaft has a drive means adapted to be brought into and out of engagement with one of the above mentioned rotatable bearing holders to be rotated in engagement with the bearing holder, a gearshift position can be obtained where the shaft is brought to rotate in the machine housing with the same angular speed as the orbiting speed of the rotor about the machine center. This solution can be convenient for propelling vehicles of different kinds.

Other objects, features and advantages of the invention is apparent from the claims and the following detailed description of exemplary embodiments.

### BRIEF DESCRIPTION OF THE DRAWING

FIG. 1 shows a rotor machine according to the invention;

FIG. 2 shows a rotor machine with portions cut away;

FIG. 3 is a longitudinal section view of a rotor machine according to FIG. 1 with a disengaged shaft;

FIG. 4 is a longitudinal section view of a rotor machine according to FIG. 1 with a shaft engaged in one of two gear shift positions;

FIG. 5 is a cross-sectional view along line 5-5 of FIG. 3;

FIG. 6 is an end view, partly in section, showing a stator and a rotor in a rotor machine according to the invention;

FIG. 7 shows, with portions broken away, an isolated rotor and a carrier for a rotor machine according to the invention;

FIG. 8 diagrammatically shows paths of movement of a rotor in a machine according to the invention; and

FIGS. 9 and 10 is a view, partly in section, of two alternatively designed rotor machines according to the invention.

### DETAILED DESCRIPTION OF EXEMPLARY EMBODIMENTS

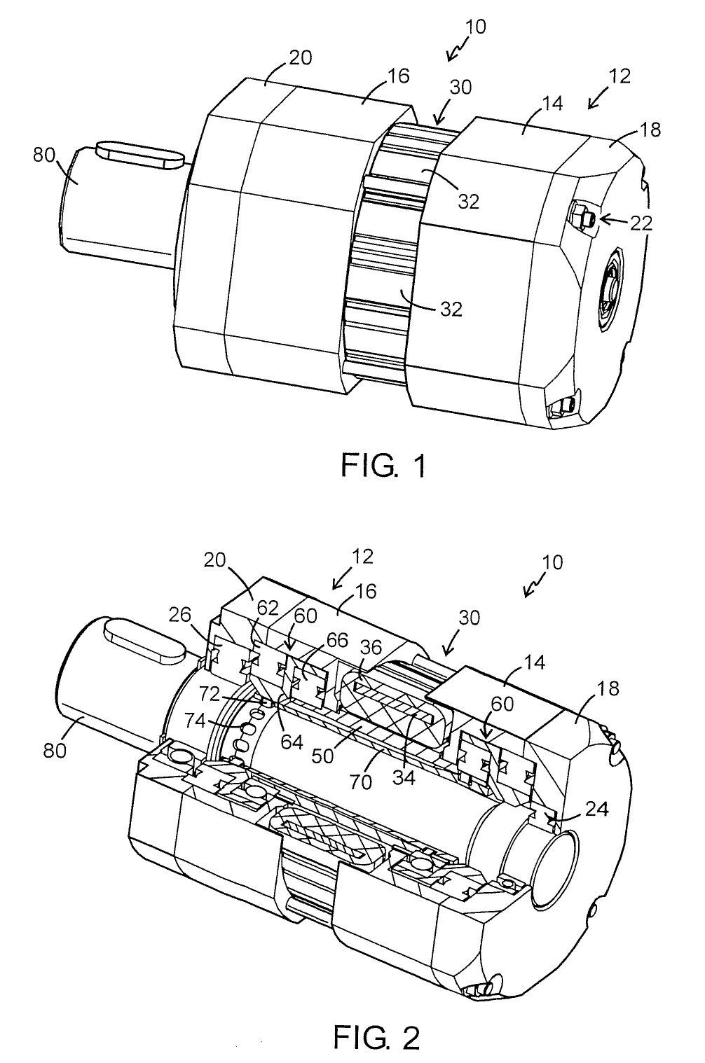

The embodiment of the rotor machine 10 shown in FIG. 1 comprises a machine housing 12 having an inner pair of machine covers or end plates 14, 16 and outer pair end plates 18, 20 connected together by a plurality of bolt assemblies 22. An annular stator 30 is supported between the end plates 14, 16.

The machine has a rotor 50 adapted to perform an orbiting motion inside the machine housing 12.

While the machine 10 may be arranged as a pure generator, in the examples shown it is supposed to be arranged as a motor 10. By a control system (not shown) the motor 10 can also have a generator function, for example for the recovery of brake energy.

As is apparent for example from FIG. 6, the annular stator 30 is provided in the shape of a plurality (twelve) of electromagnets 32 distributed around the periphery and each consisting of a core 34 and a coil 36, while the rotor is made of a magnetic material. The magnets 32 are magnetically separated from each other by gaps 38 that can be filled by a non-magnetic material. All cores 34 and filled gaps 38 may then be fabricated in a single annular piece by a co-molding method of a type known as such. It should also be possible to fabricate the annular stator 30 including the filled gaps 38 the so-called PIM (Powder Injection Molding) method and also by powder metallurgical methods.

As is apparent from the circumscribed and enlarged area of FIG. 6, the windings of the coils 36 of the electromagnets 32 are oriented in planes substantially parallel to the longitudinal axis of the rotor machine.

The effective radially inner portion of the core 34 is U-shaped in cross-section. The radially outer U-shaped outer cross-section has no magnetic function but only serves to structurally retain the coil 36 in place in the core 34 and the magnet 32 itself in the machine housing 12.

The electromagnets 32 can be fed by direct current although alternating current operation is functions in a corresponding way. AC operation may, however, be more difficult to control and may need certain measures to limit the iron losses (sddy current and hysteresis losses).

An energized magnet 32 will influence neighboring magnets by its leak flux. The magnitude of this influence depends inter alia on the distance between the magnets 32, i.e. the thickness of the air gap or the non-magnetic material 38. The fact that a portion of the flux travels through a neighboring, not energized magnet is a limited drawback as this will give a larger pole area having substantially the intended force direction. By letting the direction of the current flow be mutually opposite adjacent for adjacent coils 36, adjacent magnets 32 can be energized simultaneously by having the direction of the current flow in adjacent legs being the same (parallel).

A suitable connection method may be pulse connection: ON or OFF with full voltage and controlling the connection time of the ON pulse (PWM—Pulse Width Modulation). The most simple manner is to connect the respective coil 36 to a pulse a each energizing instance and having the connection time adapted to the actual need of torque/power, but in order to obtain a smooth or constant force and torque it may be convenient to energize the coil 36 by a plurality of shorter connection pulses. By such a digital ON/OFF connection operation, the power losses that otherwise appears in semiconductors with analog control can be avoided.

The driving torque on the rotor 50 is obtained by the force that is generated when a magnet 32 in a favorable position is energized by a current pulse from its coil 36 that generates a magnetic flux and pulls the rotor 50, being the armature, towards the pole faces 40 of the magnet core 34 (FIG. 6). The angle α between the contact point of the rotor 50 and the magnet 32 being energized may ideally be about 90 degrees. In operation, a suitable angle α and the duration of the current pulse can be varied by the control system (not shown) of the motor if many magnets are to be working together. In order to get the best possible efficiency, it may be suitable to redirect the energy of the magnets, possibly in connection with an increase of the voltage level (not shown). The angle which is most suitable depends on many factors such as speed or lead and what has been preferenced, such as efficiency/minimizing losses or high torque/high power. As far the torque is sufficient, it may be convenient to operate with a smaller angle. As mentioned above, if the need for torque is high, many adjacent magnets can be connected together at a time.

The control system can also comprise position sensors, for example formed integrally with the roller bearings 62 to be later described for the rotor. Such position sensors, which can be known Hall-type sensors, are capable of continuously signalling the position of the rotor 50 in the motor 10 to the control system. The position of the rotor 50 may however also be sensed by continuously measuring the impedance of the coils as a function of the position of the rotor in the stator. More specifically, the impedance varies with the magnitude of the air gap between the rotor 50 and the respective coil 36. Thereby the corresponding control system can operate completely without any discrete sensor. This solution may be attractive as sensors are expensive.

The rotor 50 is excentrically journalled in the machine 10 by two journal bearing assemblies 60, 60 capable of guiding the rotor to perform an orbiting motion in there machine housing 12 with a narrow gap to the electromagnets 32.

In the embodiment shown (compare FIG. 2-4) each bearing assembly 60, 60 comprises a roller bearing 62 centrally arranged in the machine housing 12, the inner ring of each bearing supporting a centric annular flange of an eccentric bearing holder 64, the eccentric annular flange of which in turn supports a roller bearing 66 for the rotor. When the rotor 50 is orbiting in the machine housing 12, its axis center C (FIG. 6), guided by the bearing assemblies 60, 60, will perform a rotational movement along a circle having a radius corresponding to the eccentricity e of the rotor 50.

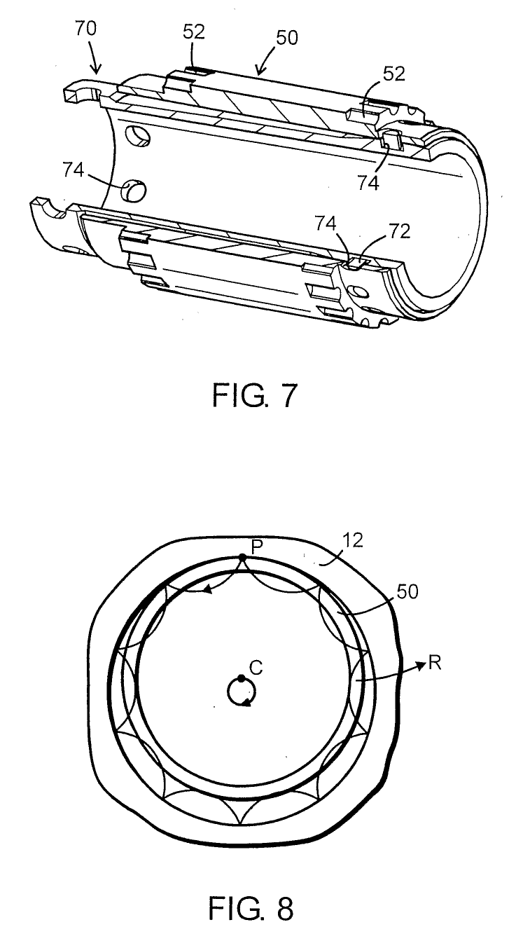

In one embodiment of the invention the rotor machine 10 has a rotationally supported central shaft 80. As is apparent from FIG. 2, the shaft 80 is rotationally supported by roller bearings 24, 26 in the end plates 18, 20. The shaft 80 is in rotational driving engagement with the rotor 50 via a carrier or a carrier sleeve 70. More precisely, the respective ends of the carrier sleeve 70 are connected on the one hand with the shaft 80 and on the other hand with the rotor 50 via drive elements 72 received in pairs of elongated openings 74 (see also FIG. 7) which, like a universal coupling, allow the carrier sleeve 70 to perform limited oscillating movements in planes containing the axis of the shaft 80.

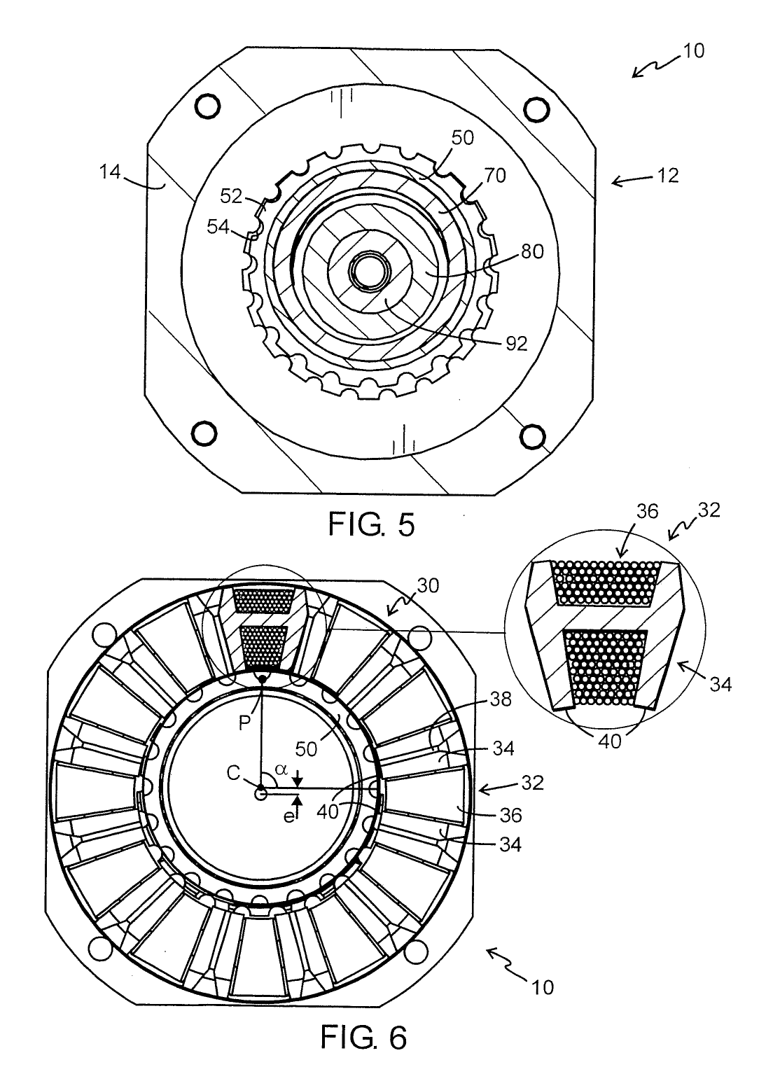

For the rotor 50 not to rotate freely about its own axis when it orbits the shaft 80 in the machine housing 12, but be capable of being connected to the shaft 80 in a gear relation for transmitting torque therebetween, the rotor is in rolling engagement with the machine housing 12. As is most clearly apparent from FIGS. 4 and 5, the rotor 50 is, via internal gear paths 52 at the outside of rotor 50, in gear engagement with internal gear paths 54 of the end caps 14, 16.

When the rotor rolls eccentric in the machine housing 12, the carrier sleeve 70 will perform a conical orbiting motion around the shaft 80. For the transmission to be free of play which is important for example in robot operation, the drive elements 70 can be prestressed in the openings 74. Instead of the cylindric shape shown, the drive elements 72 can also have a spherical shape. Other solutions to connect the carrier sleeve 70 rotationally rigid and tiltably between the rotor 50 and the shaft 80 can, for example, include spherical spline joints (not shown).

Thus, when the rotor 50 is rolling in the direction R (FIG. 8) in the machine housing 12, a point P of the rotor 50 will move along an arc of a hypocycloid for each revolution of the rolling rotor in the housing. The size of the arc depends on the difference between the inner radius of the machine housing and the outer radius of the rotor.

With a difference in radii of for example 5%, there is obtained a reduction ratio of 1:20, i.e. for each revolution of the rotor 50 in the machine housing, the shaft 80 will turn 18 degrees.

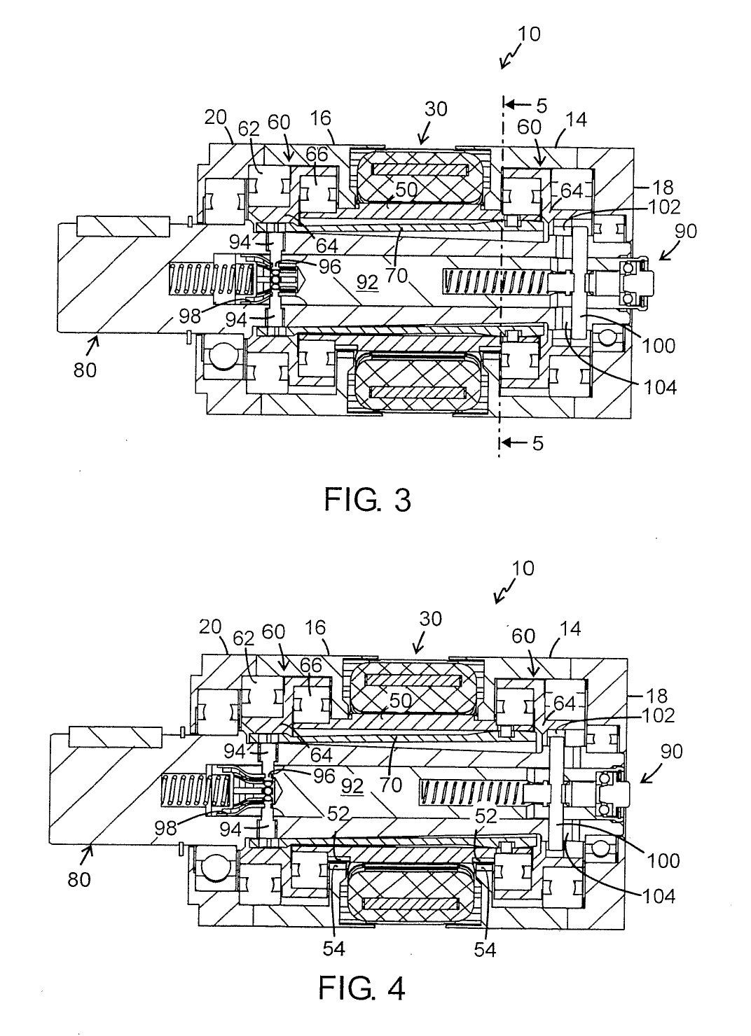

According to the modification shown in FIGS. 3 and 4 of the embodiment of FIG. 2, the rotor machine has a two-shift transmission so that in addition to the gearshift position described above when the shaft rotates with the angular speed of a point of the rotor 50, the rotor machine also has a gearshift position where the shaft 80 rotates with the rolling rpm of the rotor 50 or the angular velocity of the center of the rotor 50, as well as a neutral position therebetween.

As is more closely apparent from FIGS. 3 and 4, the shaft 80 is provided with a gearshift mechanism 90 comprising a gear shift means 92 which is axially slidable between three positions. In the vicinity of the forward, in FIG. 3 the left, end of the carrier sleeve 70, the shift means 92 has a plurality of radially inward and outward movable drive elements 94, instead of the stationary drive elements 72 of FIG. 2. Drive elements 94 have a radially inner narrowed neck portion 96 engaging guiding flanges 98 of the gear shift means 92 so that the drive elements 94 are pulled back inwards when the shift means 92 is pushed into shaft 80, and are pushed forward when the shift means 92 is pushed out of the shaft 80. Thus, when the drive elements 94 are retracted, the shaft 80 is disengaged from the carrier sleeve 70 and vice versa.

In the position according to FIG. 3 the shift means 92 is depressed only halfway into the shaft 80. The shaft 80 is then fully disengaged from the carrier sleeve 70 and the rotor 50.

At its rear end the shift means 92 has a transversely oriented drive means 100 that is out of engagement with the right-hand bearing holder 64. In the gearshift position according to FIG. 4, the drive means 100 is, however, depressed into a recess 102 to engagement with the right-hand bearing holder 64. When the bearing holder 64 rotates with the angular velocity of the rotor 50 about its rotational center, the drive means 100 will drive the shaft 80 with said angular velocity by engagement with the walls in a slot 104 of the shaft 80. In this second shift position the shaft 80 is driven in the opposite direction compared to when it is driven by the rotor 50 via the carrier sleeve 70. To utilize both shift positions as forward shift positions when the motor drives a vehicle (not shown), the driving direction of the electromagnets 32 can be reversed in connection with shifting between the both positions.

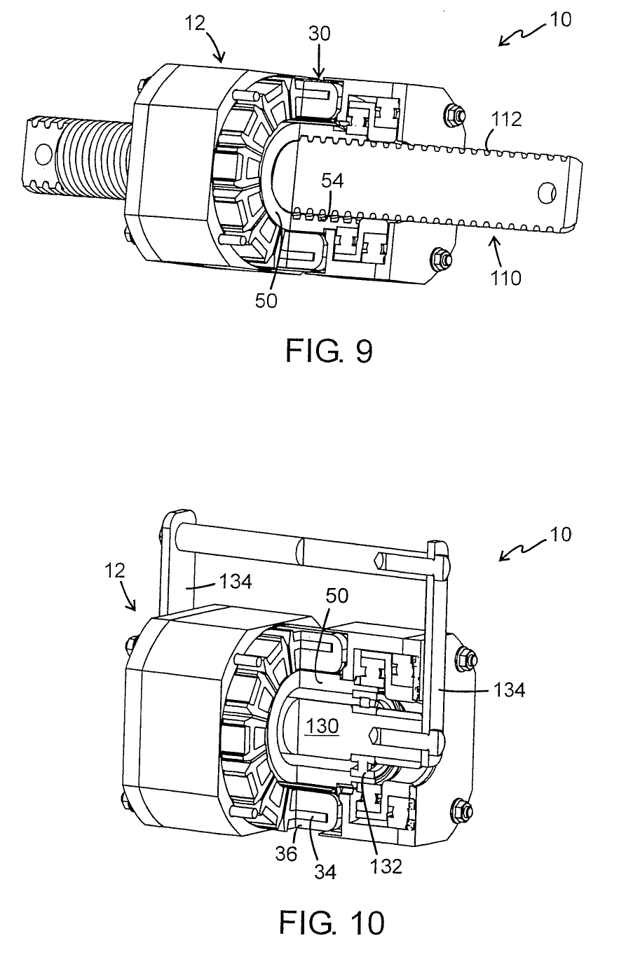

FIGS. 9 and 10 show two modifications of a rotor machine 10 according to the invention. More precisely, FIG. 9 shows a rotor machine arranged as a linear actuator, and FIG. 10 shows a rotor machine arranged as a crankshaft assembly. In these embodiments the rotor 50 needs not be in rolling engagement with the machine housing 12 but can advantageously be allowed to orbit without any rotation of its own in the machine housing 12 (not shown).

In the embodiment according to FIG. 9 the rotor 50 has internal tangential rifles and groves 54 that engage a helical thread 112 of a driving rod 110 slidably supported in a machine housing 12. When the rotor 50 performs its orbiting movement within the stator in the machine housing 12, it will displace the driving rod 110 in a desired actual direction through the machine housing 12. In order that the driving rod 110 should not rotate in the machine housing 12, it can be non-rotatably guided in the housing, for example by having a non-circular cross section (not shown) or by the ends of the driving rood 110 being non-rotatably connected to the object to be moved by the linear actuator 10 (not shown).

In the embodiment according to FIG. 10 the rotor 50 has an internally freely rotatably supported shaft 130. The bearing is provided by a pair of opposite roller bearings 132 (only one is shown in FIG. 10). If the rotor machine functions as a motor, the opposite ends of shaft 130 will orbit as crank pins of a crankshaft. This crankshaft movement maybe utilized in many different ways, for example to obtain a forward and backward movement of a connecting rod 134 that in turn is capable of driving many different kinds of machinery, such as pumps etc.

The movement of the rotor 50 in the machine housing can also be utilized to intentionally have a motor according to the invention function as a vibration generator for different applications. If the vibrations are too big in driving applications, they may be balanced by different methods for rotary machines. A simple solution may be to have the bearing holders 64 support counterweights that balance the eccentrically located rotor 50 and possibly a joining eccentrically movable components (non shown).

1.-10. (canceled)

11. An electromagnetic rotor machine of the hypocycloid type, comprising:
a machine housing;
an annular stator in the machine housing; and
an annular rotor of a magnetic material, which is supported orbiting in the machine housing to operatively engage a drive element supported in the machine housing;
wherein the rotor is supported in the machine housing by a pair of centrally arranged rotational bearings, each bearing supporting eccentric bearing holders, the bearing holders externally and rotationally supporting the rotor at the ends thereof.

12. The rotor machine according to claim 11, wherein the rotor being arranged with a rolling engagement in the machine housing, the drive element being a sleeve-shaped carrier capable of transmitting rotational movement between the rotor and a shaft concentrically journalled in the machine housing.

13. The rotor machine according to claim 12, wherein one end of the carrier being connected to an axial end of the rotor and the other end of the carrier being connected to the shaft.

14. The rotor machine according to claim 13, wherein the carrier is connected to the rotor and said shaft by engagement means engaging into elongated openings in the rotor and the shaft.

15. The rotor machine according to claim 14, comprising for bringing the carrier into and out of engagement with the shaft.

16. The rotor machine according to claim 15, wherein the shaft has a drive means capable of being brought into and out of engagement with one of said rotational bearings to be rotated with the journal bearing.

17. The rotor machine according to claim 11, wherein the drive element is a rod having a helical thread and being slidably supported in the machine housing and adapted to engage tangential rifles and grooves at an interior side of the rotor, to be displaced when the rotor is rolling inside the stator.

18. The rotor machine according to claim 11, wherein the drive element is a shaft centrically supported in the rotor and adapted to function as a crankshaft.
